(19) United States
(12) Patent Application Publication
(10) Pub. No.: US 2024/0214697 A1
(43) Pub. Date: Jun. 27, 2024

(54) IMAGE PROCESSING DEVICE, IMAGE PROCESSING METHOD, AND PROGRAM

(71) Applicant: SONY SEMICONDUCTOR SOLUTIONS CORPORATION, KANAGAWA (JP)

(72) Inventor: TOSHIAKI YAMAMOTO, KANAGAWA (JP)

(21) Appl. No.: 18/557,466

(22) PCT Filed: Feb. 4, 2022
(86) PCT No.: PCT/JP2022/004385

§ 371 Date: Oct. 26, 2023

(30) Foreign Application Priority Data
May 20, 2021 (JP) 2021-085043

(51) Int. Cl. H04N 23/951; H04N 23/45; H04N 25/47; H04N 25/53

(52) U.S. Cl. CPC H04N 23/951; H04N 23/45; H04N 25/47; H04N 25/53

(57) ABSTRACT

The present technology relates to an image processing device, an image processing method, and a program capable of generating a moving image with a high frame rate. Included are a frame-based first imaging element; an event-based second imaging element; and a generation unit that generates an interpolation frame by using frame data from the first imaging element and event data from the second imaging element. The generation unit generates the interpolation frame by adding, to the interpolation frame, integrated event data obtained by integrating the event data generated within a predetermined period of time. The present technology can be applied, for example, to an image processing device that includes a frame-based imaging element and an event-based imaging element.

### TECHNICAL FIELD

The present technology relates to an image processing device, an image processing method, and a program, for example, an image processing device, an image processing method, and a program capable of interpolating an image to achieve a high frame rate.

### BACKGROUND ART

Conventionally in an imaging device or the like, a synchronous imaging element has been used that captures image data (frames) in synchronization with a synchronization signal such as a vertical synchronization signal. Such a general synchronous imaging element acquires image data at the period of the synchronizing signal, for example, every 1/60 seconds.

In recent years, an asynchronous imaging element has come to be used that detects for each pixel address an address event that the amount of change in luminance of a pixel exceeds a threshold. Such an imaging element that detects an address event for each pixel is sometimes called a dynamic vision sensor (DVS).

A proposal has been made to control the frame rate of a synchronous imaging element based on data from an asynchronous imaging element (see PTL 1, for example).

### CITATION LIST

### Patent Literature

### [PTL 1]

Japanese Translation of PCT Application No. 2017-535999

### SUMMARY

### Technical Problem

For example, it is desired to be able to capture an image at a high frame rate even when the image of a subject is captured with low illumination.

The present technology has been made in view of such circumstances, and makes it possible to generate a moving image with a high frame rate.

### Solution to Problem

A first image processing device according to an aspect of the present technology is an image processing device including: a frame-based first imaging element; an event-based second imaging element; and a generation unit that generates an interpolation frame by using frame data from the first imaging element and event data from the second imaging element.

A first image processing method according to an aspect of the present technology is an image processing method including: by an image processing device including a frame-based first imaging element and an event-based second imaging element, generating an interpolation frame by using frame data from the first imaging element and event data from the second imaging element.

A first program according to an aspect of the present technology is a program causing a computer for controlling an image processing device including a frame-based first imaging element and an event-based second imaging element to execute processing including a step of generating an interpolation frame by using frame data from the first imaging element and event data from the second imaging element.

A second image processing device according to an aspect of the present technology is an image processing device including: a generation unit that generates an interpolation frame that interpolates between a first frame and a second frame by using event data obtained from an event-based imaging element and frame data.

A second image processing method according to an aspect of the present technology is an image processing method including: by an image processing device, generating an interpolation frame that interpolates between a first frame and a second frame by using event data obtained from an event-based imaging element and frame data.

A second program according to an aspect of the present technology is a program causing a computer to execute processing including a step of generating an interpolation frame that interpolates between a first frame and a second frame by using event data obtained from an event-based imaging element and frame data.

In the first image processing device, image processing method, program according to the aspects of the present technology a frame-based first imaging element and an event-based second imaging element are provided, and frame data from the first imaging element and event data from the second imaging element are used to generate an interpolation frame.

In the second image processing device, image processing method, and program according to the aspects of the present technology event data obtained from an event-based imaging element and frame data are used to generate an interpolation frame that interpolates between a first frame and a second frame.

Each image processing device may be a standalone device or an internal block constituting one device.

The program can be transmitted via a transmission medium or recorded on a recording medium to be provided.

### BRIEF DESCRIPTION OF DRAWINGS

FIG. 1 is a diagram illustrating a configuration of an embodiment of an image processing device to which the present technology is applied.

FIG. 2 is a diagram illustrating another configuration example of the image processing device.

FIG. 3 illustrates other configuration examples of the image processing device.

FIG. 4 illustrates frame interpolation processing.

FIG. 5 illustrates intra-frame interpolation processing.

FIG. 6 illustrates an interval Δt.

FIG. 7 illustrates inter-frame interpolation processing.

FIG. 8 is a flowchart illustrating processing of a camera unit.

FIG. 9 is a flowchart illustrating processing of an event integration unit.

FIG. 10 is a flowchart illustrating interpolation processing.

FIG. 11 is a flowchart illustrating intra-frame interpolation processing.

FIG. 12 is a flowchart illustrating inter-frame interpolation processing.

FIG. 13 illustrates how to deal with a sudden change in luminance.

FIG. 14 illustrates generation of a still image.

FIG. 15 illustrates generation of a still image.

FIG. 16 is a diagram illustrating a configuration example of a personal computer.

### DESCRIPTION OF EMBODIMENTS

Hereinafter, modes for carrying out the present technology (hereinafter referred to as “embodiments”) will be described.

### <Configuration of Image Processing Device>

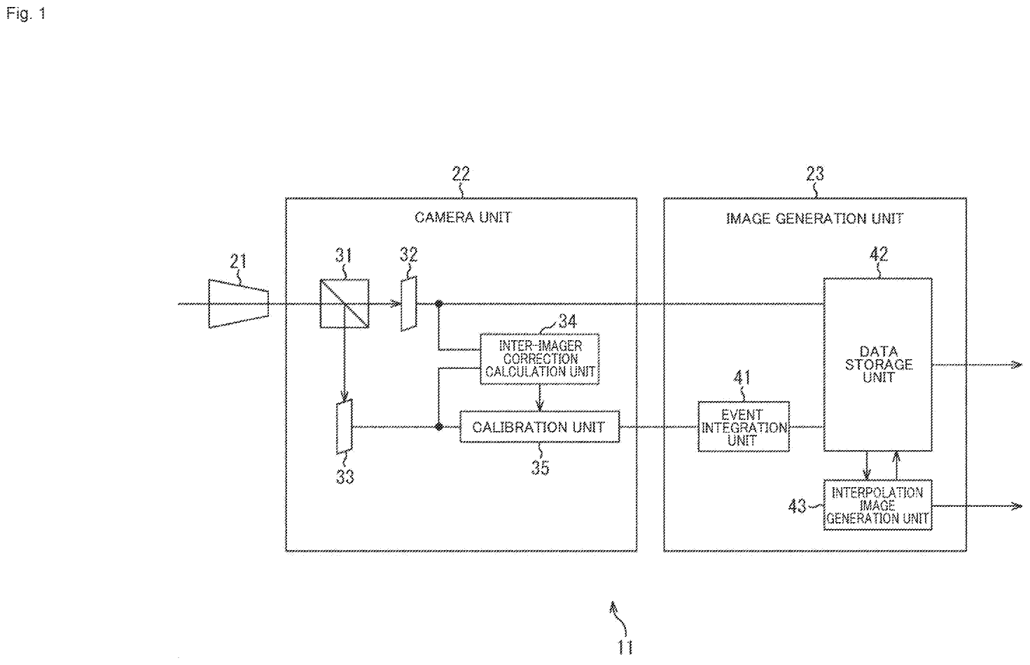

FIG. 1 is a diagram illustrating a configuration of an embodiment of an image processing device to which the present technology is applied. An image processing device 11 to which the present technology is applied includes a lens 21, a camera unit 22, and an image generation unit 23.

The camera unit 22 includes a half mirror 31, a frame-based imager 32, an event-based imager 33, an inter-imager correction calculation unit 34, and a calibration unit 35. The image generation unit 23 includes an event integration unit 41, a data storage unit 42, and an interpolation image generation unit 43.

The image processing device 11 includes the frame-based imager 32 as a synchronous imaging element that captures image data (frames) in synchronization with a synchronization signal such as a vertical synchronization signal. The frame-based imager 32 acquires image data at the period of the synchronization signal, for example, every 1/60 seconds.

The image processing device 11 includes the event-based imager 33 as an asynchronous imaging element that detects for each pixel address an address event that the amount of change in luminance of a pixel exceeds a threshold. An imaging element that detects an address event for each pixel such as the event-based imager 33 is sometimes called a dynamic vision sensor (DVS).

The image processing device 11 captures moving images and still images. The image processing device 11 uses event data obtained from the event-based imager 33 for a moving image (successive frames) captured by the frame-based imager 32 to generate frames to be interpolated (hereinafter referred to as interpolation frames) and thus generate a moving image with a high frame rate. The image processing device 11 uses event data obtained from the event-based imager 33 for a still image (one frame) captured by the frame-based imager 32 to generate a still image with noise reduced.

Light input to the camera unit 22 through the lens 21 of the image processing device 11 is split by the half mirror 31 and supplied to the frame-based imager 32 and the event-based imager 33, respectively. A prism or the like may be used instead of the half mirror 31.

As the frame-based imager 32, a general imager for visible light used in digital cameras and the like can be used. The frame-based imager 32 may be an imager that captures a color image or may be an imager that captures a black-and-white image. A case will be described below by way of example in which the frame-based imager 32 is an imager that captures a color image or a black-and-white image. However, the frame-based imager 32 according to the present technology can be applied as an infrared light (IR) imager, a polarization imager, or the like.

The event-based imager 33 asynchronously detects a change in luminance for each pixel, and outputs the detected data as information in which it is the only associated with coordinates and time. An example of the event-based imager 33 is an imager that outputs a sign of change in luminance, in other words, an imager that outputs +1 for increased luminance and −1 for reduced luminance instead of outputting a gradation. Another example of the event-based imager 33 is an imager that outputs the amount of change in luminance, in other words, an imager that outputs a gradation. In the following description, unless otherwise specified, a case will be described by way of example in which it is an imager that outputs the amount of change in luminance. Here, data output from the event-based imager 33 is referred to as event data as appropriate, and it is assumed that the event data is data including the amount of change in luminance.

The inter-imager correction calculation unit 34 calculates a normalization factor between the frame-based imager 32 and the event-based imager 33. In the case where the frame-based imager 32 and the event-based imager 33 differ in the number of pixels, normalization is performed for processing in which their numbers of pixels match. In the case where the frame-based imager 32 and the event-based imager 33 differ in sensitivity normalization is performed for processing in which their sensitivities match.

The inter-imager correction calculation unit 34 may further perform processing for eliminating a difference between the imagers other than the number of pixels and sensitivity. The inter-imager correction calculation unit 34 calculates difference information (normalization factors) on such as pixel positions and sensitivities between the imagers.

The calibration unit 35 performs correction calculations between the imagers on the data from the event-based imager 33 by using the normalization factors calculated by the inter-imager correction calculation unit 34 so that the frame data from the frame-based imager 32 and the event data from the event-based imager 33 can be appropriately combined in the subsequent stage (the image generation unit 23).

The frame data from the frame-based imager 32 is supplied to the inter-imager correction calculation unit 34 and the data storage unit 42 of the image generation unit 23. The event data from the event-based imager 33 is supplied to the inter-imager correction calculation unit 34 and the calibration unit 35. The event data from the event-based imager 33 on which correction has been performed by the calibration unit 35 is supplied to the event integration unit 41 of the image generation unit 23.

The event integration unit 41 of the image generation unit 23 accumulates event data from the event-based imager 33 input thereto via the calibration unit 35 for a certain period of time, integrates the accumulated event data, and generates change difference information for each certain period of time interval. When a change in luminance occurs, in other words, when an event occurs, the event-based imager 33 outputs event data. This means that the event-based imager 33 outputs the data irregularly. The event integration unit 41 integrates the event data during a predetermined period of time, so that the date from the event integration unit 41 (hereinafter referred to as integrated event data as appropriate) is supplied to and stored in the data storage unit 42 at a predetermined period.

The data storage unit 42 stores the moving image data captured by the frame-based imager 32 and the integrated event data from the event integration unit 41. The data storage unit 42 also stores interpolation frames to be interpolated by the interpolation image generation unit 43. The data storage unit 42 can include a memory device for temporary storage such as a dynamic random access memory (DRAM), a permanent storage device such as a hard disk drive (HDD), a solid state drive (SSD), a flash memory, and the like.

The moving image data stored in the data storage unit 42 is stored in the data storage unit 42 as it is, recorded in another recording medium, output to a processing unit (not illustrated) at a subsequent stage, and/or output to a display for display. When interpolation frames are stored in the data storage unit 42, the moving image may be output directly (rendered moving image may be output).

The interpolation image generation unit 43 uses the moving image data from the frame-based imager 32 stored in the data storage unit 42 and subject difference information at regular time intervals from the event-based imager 33 to generate an inter-frame interpolation image and an intra-frame interpolation image, which will be described later. The interpolation images generated by the interpolation image generation unit 43 are stored in the data storage unit 42, recorded in another recording medium, output to a processing unit (not illustrated) at a subsequent stage, and/or output to a display for display.

The interpolation image generation unit 43 may be configured to receive outputs from the frame-based imager 32 and the event-based imager 33 at any time, perform interpolation processing in real time, and output moving images (on-the-fly moving image output).

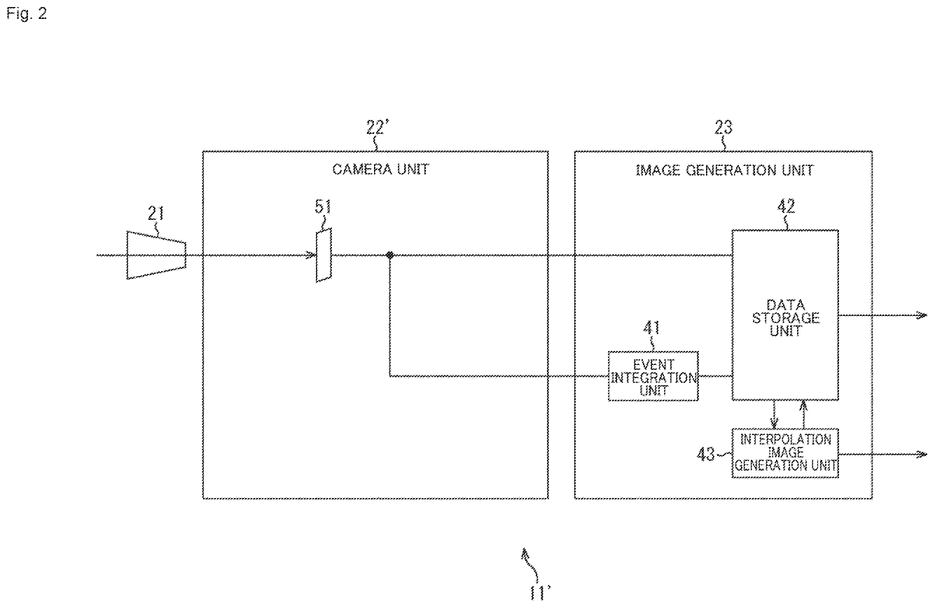

FIG. 2 is a diagram illustrating another configuration example of the image processing device 11. An image processing device 11′ illustrated in FIG. 2 (denoted with a prime symbol to distinguish it from the image processing device 11 illustrated in FIG. 1) differs in a hybrid imager 51 in which the frame-based imager 32 and the event-based imager 33 are combined.

A camera unit 22′ of the image processing device 11′ includes the hybrid imager 51, and accordingly the half mirror 31, the inter-imager correction calculation unit 34, and the calibration unit 35 are omitted. The hybrid imager 51 can also be used in this way.

In the following description, the image processing device 11 illustrated in FIG. 1 will be taken as an example.

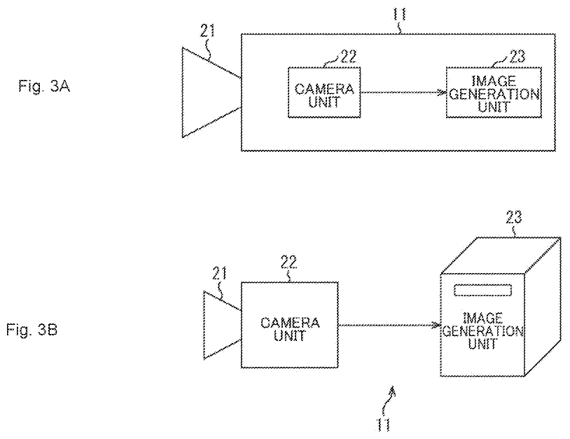

The image processing device 11 may have a configuration in which the lens 21, the camera unit 22, and the image generation unit 23 are integrated as illustrated in A of FIG. 3. As illustrated in B of FIG. 3, the lens 21 and the camera unit 22 may be integrated, and the image generation unit 23 may be configured separately.

In other words, the image generation unit 23 may be configured to be built in the image processing device 11 or may be configured to be separate from the camera unit 22. In the case where the camera unit 22 and the image generation unit 23 are configured to be separate from each other, the camera unit 22 and the image generation unit 23 may be configured to be connected to each other via a predetermined network. The image generation unit 23 may include, for example, a personal computer (PC). In the case where the image generation unit 23 is configured as an external device such as a PC, it may be configured to perform advanced post-processing using artificial intelligence (AI), neural networks, and the like.

### <Generation of Interpolation Frames>

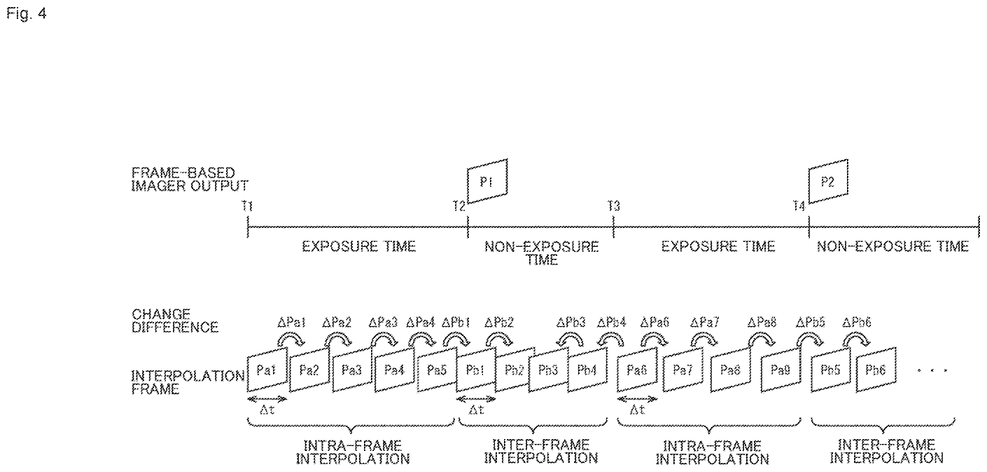

The image processing device 11 interpolates frames for the moving image (frames) captured by the frame-based imager 32 to convert the moving image into a moving image with a high frame rate. An overview of processing related to generation of an interpolation frame performed by the image processing device 11 will be described with reference to FIG. 4.

In the frame-based imager 32, a period of time T1 to time T2 is an exposure time, and a frame P1 is acquired during this exposure time. A period of time T2 to time T3 is a non-exposure time. A period of time T3 to time T4 is an exposure time, and a frame P2 is acquired during this exposure time.

The event-based imager 33 outputs event data irregularly while the event integration unit 41 outputs integrated event data regularly Referring to FIG. 4, during the exposure time of time T1 to time T2, integrated event data ΔPa1, integrated event data ΔPa2, integrated event data ΔPa3, integrated event data ΔPa4, and integrated event data ΔPa5 are output (held in the data storage unit 42) at intervals of Δt.

Within the non-exposure time of time T2 to T3, integrated event data ΔPb1, integrated event data ΔPb2, integrated event data ΔPb3, and integrated event data ΔPb4 are output (held in the data storage unit 42) at intervals of A t.

Within the exposure time of time T3 to T4, integrated event data ΔPa6, integrated event data ΔPa7, and integrated event data ΔPa8 are output (held in the data storage unit 42) at intervals of Δt.

Generating interpolation frames during the exposure time is described as intra-frame interpolation, and generating interpolation frames during the non-exposure time is described as inter-frame interpolation. An interpolation frame to be interpolated in intra-frame interpolation is described as an interpolation frame Pa, and an interpolation frame to be interpolated in inter-frame interpolation is described as an interpolation frame Pb.

The integrated event data used for intra-frame interpolation, in other words, the integrated event data generated during the exposure time is described as integrated event data ΔPa. The integrated event data used for inter-frame interpolation, in other words, the integrated event data generated during the non-exposure time is described as integrated event data ΔPb.

For the purpose of explanation, the integrated event data ΔPa and the integrated event data ΔPb will be separately described below. However, the integrated event data ΔPa and the integrated event data ΔPb are each data obtained by integrating event data generated within a predetermined period of time and do not indicate that the integrated event data ΔPa and the integrated event data ΔPb are different data.

In the example illustrated in FIG. 4, intra-frame interpolation is performed during the exposure time of time T1 to time T2, thereby generating five frames of interpolation frames Pa1 to Pa5. The interpolation frames Pa1 to Pa5 are generated using the frame P1 and the integrated event data ΔPa1 to ΔPa4.

Inter-frame interpolation is performed during the non-exposure time of time T2 to time T3, thereby generating four frames of interpolation frames Pb1 to Pb4. The interpolation frames Pb1 to Pb4 are generated using the interpolation frame Pa5, the interpolation frame Pa6 generated by intra-frame interpolation performed during the period of time T3 to time T4, and the integrated event data ΔPb1 to ΔPb4.

Intra-frame interpolation is performed during the exposure time of time T3 to time T4, thereby generating four frames of interpolation frames Pa6 to Pa9. The interpolation frames Pa6 to Pa9 are generated using the frame P2 and the integrated event data ΔPa6 to ΔPa8.

As described above, the intra-frame interpolation is interpolation processing in which the frame data obtained from the frame-based imager 32 and the event data (integrated event data) obtained from the event-based imager 33 are used to generate the interpolation frames Pa.

The inter-frame interpolation is processing in which the integrated event data obtained from the event-based imager 33 and the interpolation frames Pa obtained in the intra-frame interpolation are used to generate the interpolation frames Pb.

### <Intra-Frame Interpolation>

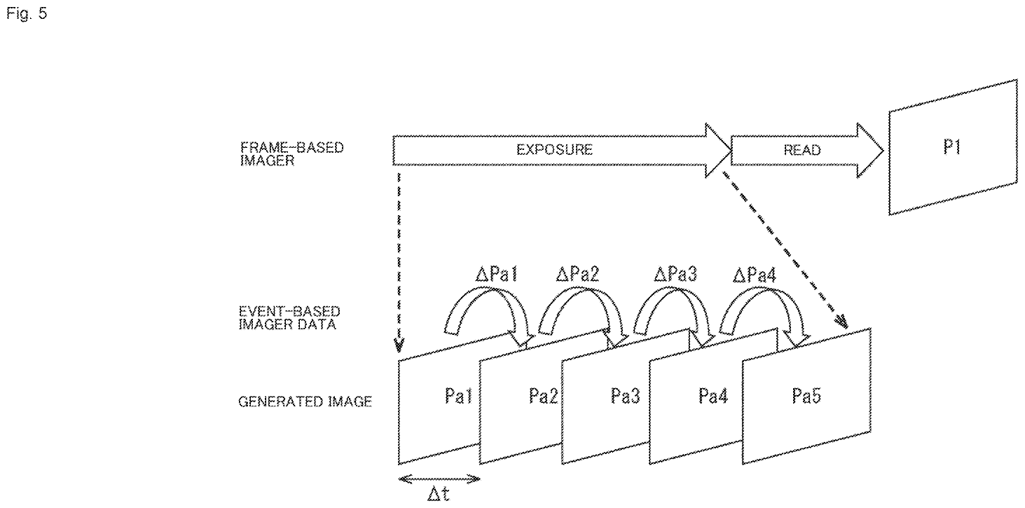

The intra-frame interpolation will be further described with reference to FIG. 5. In FIG. 5, the intra-frame interpolation performed during the exposure time of time T1 to time T2 in FIG. 4 is taken as an example.

In FIG. 5, a frame P1 represents a frame (an image forming a moving image) captured by the frame-based imager 32 in the exposure time. The event data output from the event-based imager 33 in the predetermined interval Δt is integrated by the event integration unit 41 (FIG. 1) and supplied as integrated event data ΔPa to the interpolation image generation unit 43. In the example illustrated in FIG. 5, integrated event data ΔPa1 to Pa4 are generated during the exposure time.

Interpolation frames Pa1 to Pa5 are frames interpolated by performing the intra-frame interpolation processing, in other words, newly generated frames. Here, the following relationships hold between the frame P1 and the interpolation frames Pa1 to Pa5. In each equation given below, the frame P1 is represented as P1, the interpolation frames Pa1 to Pa5 are represented as Pa1, Pa2, Pa3, Pa4, and Pa5, respectively and the integrated event data ΔPa1 to Pa4 are represented as ΔPa1, ΔPa2, ΔPa3, and ΔPa4, respectively.

$$P 1 = ( P a 1 + P a 2 + P a 3 + P a 4 + P a 5 ) / 5 \qquad ( 1 )$$

An image obtained by averaging the interpolation frames Pa1 to Pa5 is similar to the frame P1, and the above relational Equation (1) holds.

The following relational Equation (2) holds between the interpolation frames Pa1 to Pa5 and the integrated event data ΔPa1 to Pa5.

$$P a 2 = P a 1 + Δ P a 1 \qquad ( 2 )$$

$$P a 3 = P a 2 + Δ P a 2 = P a 1 + Δ P a 1 + Δ P a 2$$

$$P a 4 = P a 3 + Δ P a 3 = P a 1 + Δ P a 1 + Δ P a 2 + Δ P a 3$$

$$P a 5 = P a 4 + Δ P a 4 = P a 1 + Δ P a 1 + Δ P a 2 + Δ P a 3 + Δ P a 4$$

The interpolation frame Pa2 is a frame obtained by adding the integrated event data ΔPa1, which is a difference from the interpolation frame Pa1, to the previous interpolation frame Pa1. Similarly the interpolation frame Pa3 is a frame obtained by adding the integrated event data ΔPa2, which is a difference from the interpolation frame Pa2, to the previous interpolation frame Pa2.

Similarly the interpolation frame Pa4 is a frame obtained by adding the integrated event data ΔPa3, which is a difference from the interpolation frame Pa3, to the previous interpolation frame Pa3. Similarly the interpolation frame Pa5 is a frame obtained by adding the integrated event data ΔPa4, which is a difference from the interpolation frame Pa4, to the previous interpolation frame Pa4.

When Equation (2) is substituted into Equation (1), the following Equation (3) is obtained.

$$P 1 \times 5 = Pa 1 \times 5 + Δ Pa 1 \times 4 + Δ Pa 2 \times 3 + Δ Pa 3 \times 2 + Δ Pa 4 \qquad ( 3 )$$

From Equation (3), it can be seen that the frame P1 can be expressed using the interpolation frame Pa1 and the integrated event data ΔPa1 to Pa4. Furthermore, the following Equation (4) is obtained by transforming Equation (3) into an Equation related to the interpolation frame Pa1.

$$Pa 1 = P 1 - ( Δ P a 1 \times 4 + Δ P a 2 \times 3 + Δ P a 3 \times 2 + Δ P a4 ) / 5 \qquad ( 4 )$$

From Equation (4), it can be seen that the interpolation frame Pa1 can be generated using the frame P1 and the integrated event data ΔPa1 to ΔPa4.

When the interpolation frame Pa1 is generated based on Equation (4), the interpolation frames Pa2 to Pa5 can also be generated from Equation (2). Specifically, for example, the interpolation frame Pa2 is generated by adding the integrated event data ΔPa1 to the generated interpolation frame Pa1. Similarly the interpolation frames Pa3 to Pa5 are generated using the interpolation frames Pa2 to Pa4 and the integrated event data ΔPa2 to Pa4.

Equation (4) can be expressed generally as the following Equation (5).

$$\begin{matrix}[ Math . 1 ] & \\ P {a}_{1} = P - \frac{1}{n} ( ( n - 1 ) {Δ Pa}_{1} + ( n - 2 ) {Δ Pa}_{2} … + Δ P {a}_{n - 1} ) & ( 5 )\end{matrix}$$

In Equation (5), Pa1 represents an interpolation frame Pa that is first generated in the intra-frame interpolation. P represents a frame P acquired in the exposure time during which the intra-frame interpolation is performed. n represents the number of interpolation frames to be generated in the intra-frame interpolation, for example, n=5 in the example illustrated in FIG. 5.

ΔPa₁ to ΔPₙ₋₁ represent integrated event data ΔPa₁ to ΔPaₙ₋₁ acquired in the exposure time during which the intra-frame interpolation is performed.

The number of interpolation frames n is calculated by the following Equation (6).

$$\begin{matrix}[ Math . 2 ] & \\ INTRA - FRAME INTERPOLATION NUMBER = INTERPOLATION RATE \times \frac{EXPOSURE TIME}{\begin{matrix}EXPOSURE TIME + \\ NON - EXPOSURE TIME\end{matrix}} & ( 6 )\end{matrix}$$

The intra-frame interpolation number n is a value obtained by dividing the exposure time by the sum of the exposure time and the non-exposure time and then multiplying the resulting quotient by an interpolation rate. When an auto exposure (AE) function is enabled, the exposure time changes dynamically. Therefore, when the exposure time changes dynamically, the exposure time is acquired for each frame and then the intra-frame interpolation number n is calculated and set for each frame.

The interpolation rate is a value representing how many times the original moving image is to be interpolated, and is defined by the following Equation (7).

$$\begin{matrix}[ Math . 3 ] & \\ INTERPOLATION RATE = \frac{FRAME RATE AFTER INTERPOLATION}{FRAME RATE BEFORE INTERPOLATION} & ( 7 )\end{matrix}$$

The interpolation rate may be defined as a value obtained by dividing the frame rate after interpolation by the interpolation frame rate before interpolation.

For example, in the example illustrated in FIG. 5, the interpolation rate is 5 because five interpolation frames are generated during the exposure time. The interpolation rate or the frame rate after interpolation may be a preset value, or may be set by the user.

The intra-frame interpolation number n is related to the interval Δt (the period of time during which the event data is accumulated) for generating the integrated event data ΔPa. Specifically the intra-frame interpolation number n refers to how many interpolation frames are to be generated during the exposure time. In other words, the exposure time is evenly divided by the intra-frame interpolation number n, and an interpolation frame Pa is generated at the time interval as the result of division. The time obtained by evenly dividing the exposure time corresponds to the interval Δt, the integrated event data ΔPa is generated at the interval Δt, and the interpolation frame Pa is generated accordingly. The interval Δt is calculated by the following Equation (8).

$$\begin{matrix}[ Math . 4 ] & \\ Δ t = \frac{1}{\begin{matrix}FRAME RATE BEFORE INTERPOLATION \times \\ INTERPOLATION RATE\end{matrix}} & ( 8 )\end{matrix}$$

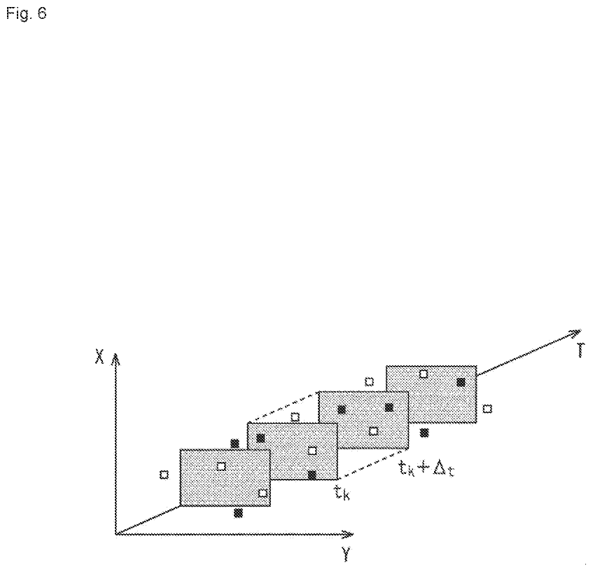

The interval Δt is a value obtained by dividing 1 by a value obtained by multiplying the frame rate before correction by the interpolation rate. As illustrated in FIG. 6, event data generated between a predetermined time tk and time tk+Δt are integrated and output as integrated event data ΔPa at time tk+Δt.

In FIG. 6, white squares represent pixels whose luminance has changed to brighter, and black squares represent pixels whose luminance has changed to darker. The integrated event data ΔPa is generated by integrating the event data accumulated during the interval Δt.

The event data output from the event-based imager 33 is expressed, for example, by the following Equation (9). Hereinafter, event data will be represented by e.

$$e = {[ x , y , p ]}^{te} \qquad ( 9 )$$

The event data e has, as elements, coordinates [x, y] at which an event occurs, and the amount of change in luminance p or the sign p of change in luminance at the corresponding pixel. For a gradation output as event data, p is a gradation output, and for no gradation output, p is a sign of +1 or −1. In Equation (9), te is the time when the event occurred.

In the case of the event data e being color, the event data e is represented as follows.

$$e = {[ x , y , {p}_{R} , {p}_{G} , {p}_{B} ]}^{te} \qquad ( 10 )$$

In Equation (10), p_{R} represents the amount (or sign) of change in luminance for red (R), p_{G} represents the amount (or sign) of change in luminance for green (G), and p_{B} represents the amount (or sign) of change in luminance for blue (B). In the following description, the event data e will be described as an example of data represented by Equation (9). However, for the event data e being color, the event data e can be replaced with data represented by Equation (10) as appropriate for implementation.

If the number of pixels and sensitivity of the event-based imager 33 are different from those of the frame-based imager 32, the event data e needs to be normalized to data suitable for output from the frame-based imager 32 in order to generate an interpolation frame Pa by the processing as described above.

Event data e normalized by the calibration unit 35 (FIG. 1) (referred to as event data e_{N}) is represented by the following Equation (11).

$$e N = {[ {x}_{N} , {y}_{N} , {p}_{N} ]}^{te} \qquad ( 11 )$$

Event data eₙ calibrated by the calibration unit 35 is supplied to the event integration unit 41 (FIG. 1). The event integration unit 41 integrates the event data eₙ supplied from the calibration unit 35 during the interval Δt.

The event integration unit 41 performs calculation based on the following Equation (12) to calculate the integrated event data ΔPa.

$$Δ {Pa}_{k} = {\sum }_{t = {t}_{k}}^{{t}_{k} + Δ t} {[ {x}_{N} , {y}_{N} , {p}_{N} ]}^{t} \qquad ( 12 )$$

Equation (12) is an equation for integrating normalized event data e_{N}, which is event data e generated between time tk and time tk+Δt, that is, during the interval Δt, as illustrated in FIG. 6, for example.

Pixels with the upper limit or lower limit of the dynamic range on a frame basis are excluded from the calculation targets for Equation (12). This is to exclude luminance changes outside the dynamic range.

In this way integrated event data ΔPa required to generate an interpolation frame Pa in the intra-frame interpolation, an interval Δt required to calculate the integrated event data ΔPa, and the like are calculated. Then, using these values, a frame P, and the integrated event data ΔPa, intra-frame interpolation processing is performed to generate an interpolation frame Pa.

### <Inter-Frame Interpolation>

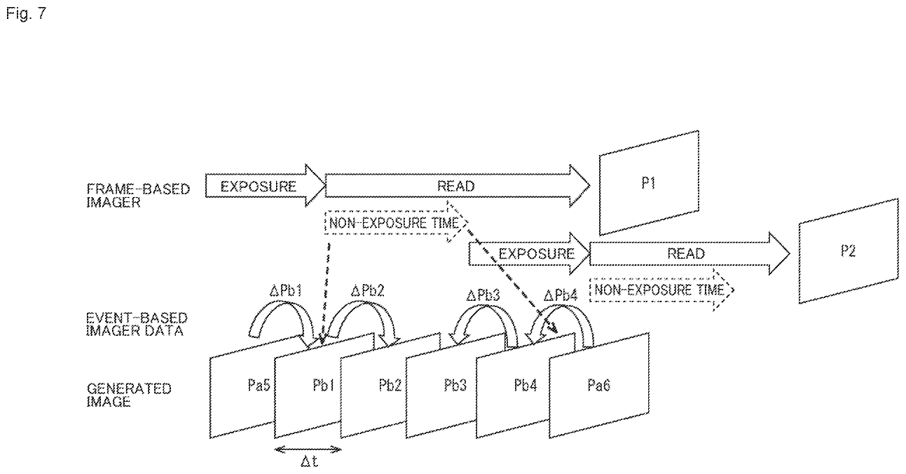

The inter-frame interpolation will be further described with reference to FIG. 7. In FIG. 7, the inter-frame interpolation performed during the exposure time of time T2 to time T3 in FIG. 4 is taken as an example.

In FIG. 7, frames P1 and P2 represent frames (images forming a moving image) captured by the frame-based imager 32 in the exposure time. The event data output from the event-based imager 33 during a predetermined interval Δt are integrated to generate integrated event data ΔPb. In the example illustrated in FIG. 7, integrated event data ΔPb1 to Pb4 are generated during the non-exposure time.

Here, the integrated event data ΔPb related to the inter-frame interpolation will be described as integrated event data ΔPb, but event data and processing of calculating integrated event data from that event data are the same as those for the integrated event data ΔPa described above. The period in which an interpolation frame Pb is generated corresponds to the interval Δt, and for this interval Δt, the interval Δt related to the intra-frame interpolation described above is used.

The inter-frame interpolation is interpolation performed during the non-exposure time. The inter-frame interpolation is interpolation processing that is performed when the frame-based imager 32 takes a long time to read pixel values from the frame-based imager 32 and as a result has a non-exposure time because of having a large number of pixels.

In the example illustrated in FIG. 7, the interpolation frames Pb1 to Pb4 are frames interpolated by performing the inter-frame interpolation processing, in other words, newly generated frames. The inter-frame interpolation is performed using an interpolation frame Pa generated by intra-frame interpolation using a frame P being read and an interpolation frame Pa generated by intra-frame interpolation using a frame P captured next to the frame P being read.

In the example illustrated in FIG. 7, the frame P being read is a frame P1, and the frame P captured next to the frame P1 is a frame P2. The interpolation frames Pa used for the inter-frame interpolation are an interpolation frame Pa5, which is the last frame among the interpolation frames Pa generated when the intra-frame interpolation is performed on the frame P1, and an interpolation frame Pa6, which is the top frame generated when the intra-frame interpolation is performed on the frame P2.

In the inter-frame interpolation, the non-exposure time is divided into the first half and the second half. In the first half, the interpolation frame Pa5, which is the last image among the plurality of interpolation frames Pa generated by the intra-frame interpolation using the frame P1 being read, is used. In the second half, the interpolation frame Pa6, which is the top image among the plurality of interpolation frames Pa generated by the intra-frame interpolation using the frame P2 being read next to the frame P1, is used.

In the inter-frame interpolation, as in the example illustrated in FIG. 7, for four interpolation frames Pb1 to Pb4 to be generated, the interpolation frame Pb1 and the interpolation frame Pb2, which are located in the first half of the non-exposure time, are generated using the interpolation frame Pa5, and the interpolation frame Pb3 and the interpolation frame Pb4, which are located in the second half of the non-exposure time, are generated using the interpolation frame Pa.

The first interpolation frame Pb1 in the inter-frame interpolation is generated by adding the integrated event data ΔPb1 to the interpolation frame Pa5. The interpolation frame Pb2, which is next to the interpolation frame Pb1, is generated by adding the integrated event data ΔPb2 to the interpolation frame Pb1. They are expressed as the following equations.

$$Pb 1 = P a 5 + Δ Pb 1 \qquad ( 13 )$$

$$Pb 2 = Pb 1 + Δ Pb 2 = P a 5 + Δ Pb 1 + Δ Pb 2$$

The interpolation frame Pb2 may be generated by adding the integrated event data ΔPb2 to the interpolation frame Pb1, or may be generated by adding the integrated event data ΔPb1 and the integrated event data ΔPb2 to the interpolation frame Pa5.

The last interpolation frame Pb4 in the inter-frame interpolation is generated by subtracting the integrated event data ΔPb4 from the interpolation frame Pa6. The interpolation frame Pb3, which is one before the interpolation frame Pb4, is generated by subtracting the integrated event data ΔPb3 from the interpolation frame Pb4. They are expressed as the following equations.

$$Pb 4 = P a 6 \cdot Δ Pb 4 \qquad ( 14 )$$

$$Pb 3 = Pb 4 \cdot Δ Pb 3 = P a 6 \cdot Δ Pb 4 \cdot Δ Pb 3$$

The interpolation frame Pb3 may be generated by subtracting the integrated event data ΔPb3 from the interpolation frame Pb4, or may be generated by subtracting the integrated event data ΔPb3 and the integrated event data ΔPb4 from the interpolation frame Pa6.

In this way the interpolation frame Pb3 and the interpolation frame Pb4, which are located in the second half of the non-exposure time, are generated using the interpolation frame Pa6 that is close in time.

In this way in the first half of the non-exposure time, the interpolation frame Pb is generated by adding the integrated event data ΔPb to the interpolation frame Pa generated by the intra-frame interpolation. On the other hand, in the second half of the non-exposure time, the interpolation frame Pb is generated by subtracting the integrated event data ΔPb from the interpolation frame Pa generated by the intra-frame interpolation.

As in the example illustrated in FIG. 7, when an even number of interpolation frames are generated in the inter-frame interpolation, the same number of frames are generated in each of the first and second halves of the non-exposure time. When an odd number of interpolation frames are generated in the inter-frame interpolation, the numbers of frames in the first half and the second half of the non-exposure time are different.

For example, when five interpolation frames Pb are generated in the inter-frame interpolation, two frames may be generated in the first half of the non-exposure time and three frames may be generated in the second half, or three frames may be generated in the first half and two frames may be generated in the second half.

When an odd number of interpolation frames Pb are generated, whether to include the interpolation frame Pb in the middle in the first half or the second half of the non-exposure time, in other words, whether to generate the interpolation frame by adding integrated event data ΔPb or by subtracting integrated event data ΔPb may be set in advance. For example, the interpolation frame Pb in the middle may be set to be generated by subtracting the integrated event data ΔPb.

When an interpolation frame Pb in the middle is generated, integrated event data ΔPb to be added for adding the integrated event data ΔPb and integrated event data ΔPb to be subtracted for subtracting the integrated event data ΔPb are compared with each other, and as a result, the smaller integrated event data ΔPb may be set to be used. In other words, an interpolation frame Pb may be generated using integrated event data ΔPb with the smaller amount of change.

The number m of interpolation frames Pb to be generated by the inter-frame interpolation processing is calculated by the following Equation (15).

$$\begin{matrix}[ Math . 6 ] & \\ INTER - FRAME INTERPOLATION NUMBER = INTERPOLATION RATE \times \frac{NON - EXPOSURE TIME}{\begin{matrix}EXPOSURE TIME + \\ NON - EXPOSURE TIME\end{matrix}} & ( 15 )\end{matrix}$$

The inter-frame interpolation number m is a value obtained by adding the interpolation rate to a value obtained by dividing the non-exposure time by the sum of the exposure time and the non-exposure time. When the auto exposure (AE) function is enabled, the exposure time (non-exposure time) changes dynamically. Therefore, when the exposure time changes dynamically the exposure time and the non-exposure time are acquired (calculated) for each frame and then the inter-frame interpolation number m is calculated and set for each frame.

As the interpolation rate included in Equation (15), a value set in advance (obtained by calculation) is used, or a value set by the user is used, as in the case described above. The interval Δt obtained from the above Equation (8) using the interpolation rate is also used as the interval. At for the inter-frame interpolation processing.

A case has been described above by way of example in which the frame to be used for the inter-frame interpolation is an interpolation frame Pa generated during the intra-frame interpolation processing. The intra-frame interpolation processing and the inter-frame interpolation processing may be configured to be performed at the time of capturing an image, in other words, to be performed in real time at the same time as capturing. Alternatively, interpolation frames Pa generated by the intra-frame interpolation may be recorded and the inter-frame interpolation may be performed using the recorded interpolation frames Pa at a timing after capturing.

As the interpolation frames to be used for the inter-frame interpolation, frames other than the generated interpolation frames may be used. For example, in FIG. 7, using the frame P1 instead of the interpolation frame Pa5 and using the frame P2 instead of the interpolation frame Pa6, the above-described processing may be performed to perform the inter-frame interpolation.

The intra-frame interpolation processing described above may be performed in the same manner as the inter-frame interpolation processing, and all interpolation frames to be generated may be generated by the inter-frame interpolation processing described above. For example, in the example illustrated in FIG. 7, in the first half of a period obtained by adding the exposure time for acquiring the frame P2 and the non-exposure time for reading the frame P2, an interpolation frame may be generated by adding the integrated event data ΔPb to the frame P1, and in the second half, an interpolation frame may be generated by subtracting the integrated event data ΔPb from the frame P2.

### <Processing of Camera Unit>

The processing of the image processing device 11 (FIG. 1), which generates an interpolation frame Pa by the intra-frame interpolation processing and an interpolation frame Pb by the inter-frame interpolation processing to generate a moving image with a high frame rate, as described above, will be further described.

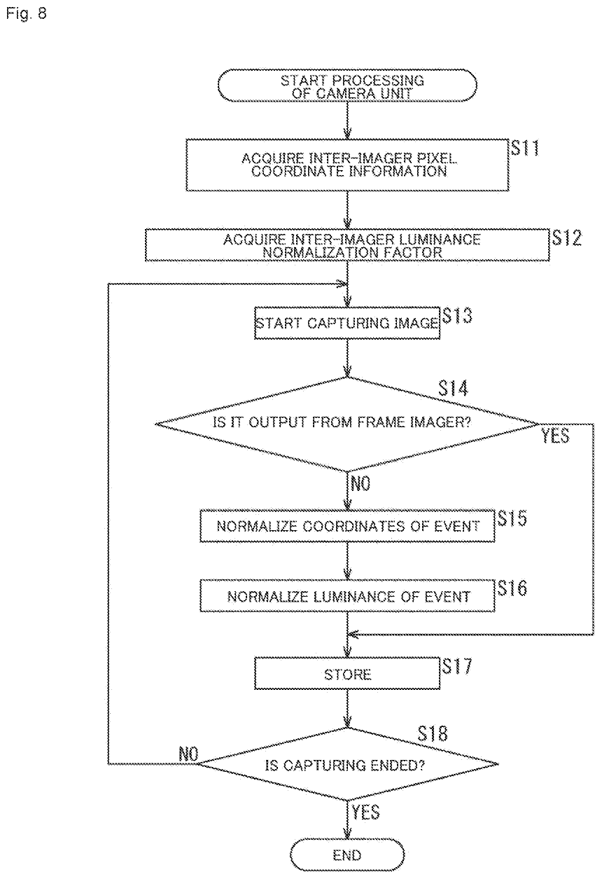

Processing of the camera unit 22 of the image processing device 11 will be described with reference to a flowchart of FIG. 8. The processing of the camera unit 22 illustrated in the flowchart of FIG. 8 is started, for example, when the camera unit 22 is activated.

In step S11, inter-imager pixel coordinate transformation information between the frame-based imager 32 and the event-based imager 33 is acquired. The pixel coordinate transformation information is stored as data obtained in the manufacturing process of the camera unit 22 in, for example, the inter-imager correction calculation unit 34. The pixel coordinate transformation information is factory adjusted values.

In step S12, an inter-imager luminance normalization factor between the frame-based imager 32 and the event-based imager 33 is acquired. The luminance normalization factor is stored as data obtained in the manufacturing process of the camera unit 22 in, for example, the inter-imager correction calculation unit 34. The luminance normalization factor is also a factory adjusted value, like the pixel coordinate transformation information.

In step S13, capturing an image is started by the camera unit 22. Capturing of a moving image by the frame-based imager 32 and detection of an event by the event-based imager 33 are started.

In step S14, it is determined whether or not the output is from the frame-based imager 32. If the output is from the frame-based imager 32, that is, the output is data of a frame P, the processing proceeds to step S17. In step S17, the output from the frame-based imager 32 is output to and stored in the data storage unit 42 of the image generation unit 23.

On the other hand, if it is determined in step S14 that the output is not from the frame-based imager 32, in other words, if it is determined that the output is from the event-based imager 33, the processing proceeds to step S15.

In step S15, the coordinates of pixel where the event occurred are transformed into coordinates of the frame. The calibration unit 35 uses the pixel coordinate transformation information acquired in step S11 to transform the coordinate information on the event into coordinates of the frame-based imager 32.

In step S16, the luminance of the pixel where the event occurred is converted to a luminance of the frame. The calibration unit 35 uses the luminance normalization factor acquired in step S12 to convert the change in luminance of the event into an amount of change in luminance of the frame-based imager 32.

In step S17, the event data calibrated by the calibration unit 35 is output to the event integration unit 41 (FIG. 1) of the image generation unit 23 and stored until the event integration unit 41 starts integration processing.

In step S18, it is determined whether or not the capturing has been ended. For example, when the user operates a button to be operated at the end of capturing, it is determined in step S18 that the capturing has been ended, and the processing in the camera unit 22 ends accordingly. On the other hand, if it is determined in step S18 that the capturing has not been ended, the processing returns to step S13 to repeat the subsequent steps of processing. In other words, the frame-based imager 32 continues to capture a moving image, and the event-based imager 33 continues to detect an event.

### <Processing of Event Integration Unit>

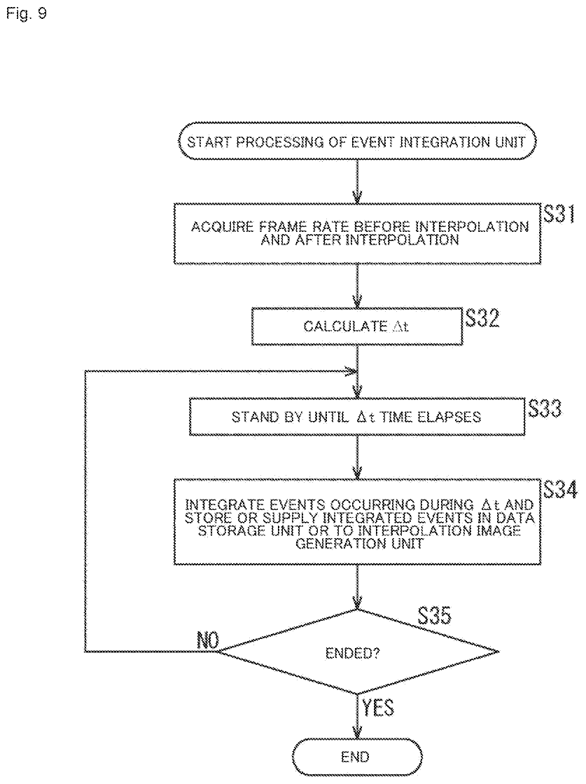

Processing of the event integration unit 41 (FIG. 1) of the image generation unit 23 will be described with reference to a flowchart of FIG. 9.

In step S31, the frame rate before correction and the frame rate after correction are acquired. In step S32, an interval Δt is calculated. The interval Δt is calculated by Equation (8) as described above. The interpolation rate in Equation (8) is calculated based on Equation (7). Equation (7) is an equation for calculating an interpolation rate by dividing the frame rate after interpolation by the interpolation frame rate after interpolation.

The interval Δt is calculated in step S32 based on the frame rate before correction and the frame rate after correction, which are acquired in step S31, and Equations (7) and (8).

In step S33, a standby state is maintained until the interval Δt time elapses. Event data is supplied from the event-based imager 33 to the event integration unit 41 through the calibration unit 35 even in the standby state. The event integration unit 41 accumulates the event data supplied during the time interval Δt.

In step S34, the event data generated during the interval Δt is integrated, and the integrated event data thus integrated is supplied to and stored in the data storage unit 42. Alternatively it is supplied to the interpolation image generation unit 43. In the following description, it is assumed that the integrated event data is temporarily stored in the data storage unit 42 and then read by the interpolation image generation unit 43 as necessary when an interpolation frame is generated.

In step S35, it is determined whether or not to end the processing. For example, when the capturing by the camera unit 22 ends, the processing by the event integration unit 41 also ends. Alternatively when no event data is supplied from the calibration unit 35 within a predetermined period of time, it is determined in step S35 to end the processing. If it is determined in step S35 not to end the processing, the processing is returned to step S33 to repeat the subsequent steps of processing. In other words, the generation of integrated event data continues.

### <Interpolation Processing>

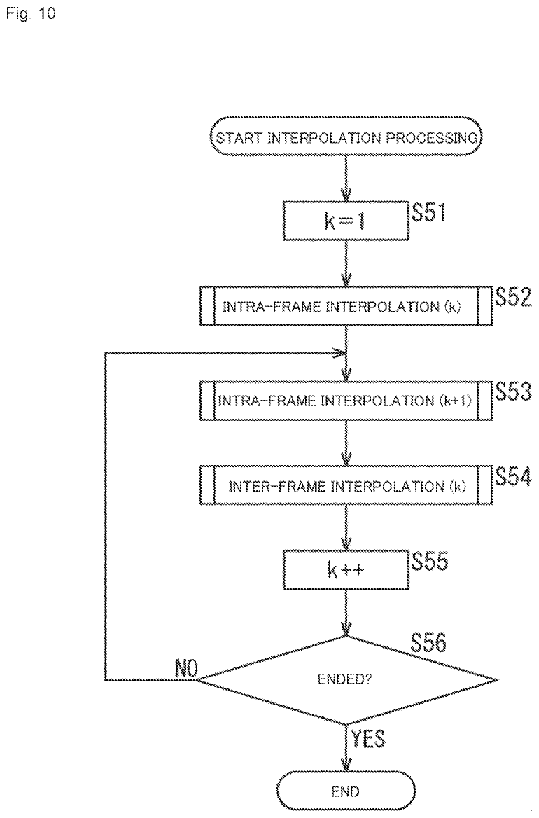

While the processing of the camera unit 22 and the processing of the event integration unit 41, which have been described above, are performed, the processing related to the generation of interpolation frames in the interpolation image generation unit 43 is also performed. The interpolation processing performed by the interpolation image generation unit 43 will be described with reference to a flowchart of FIG. 10.

In step S51, a number k assigned to a frame P to be processed is set to 1. In step S52, intra-frame interpolation (k) is performed on the frame P assigned the number k. In step S53, intra-frame interpolation (k+1) is performed on a frame P to which a number k+1 is assigned.

In step S54, inter-frame interpolation (k) is performed on the frame P assigned the number k. In order to perform the inter-frame interpolation (k), the last interpolation frame Pa generated in the intra-frame interpolation (k) and the top interpolation frame Pa generated in the intra-frame interpolation (k+1) are required. Therefore, in step S52, the intra-frame interpolation (k) is performed to acquire the last interpolation frame Pa, in step S53, the intra-frame interpolation (k+1) is performed to acquire the top interpolation frame Pa, and then in step S54, the inter-frame interpolation (k) is performed.

Refer to FIG. 4 again. In FIG. 4, it is assumed that the frame P to which k=1 is assigned is the frame P1, and the frame P1 is to be processed. In such a case, in step S52, the processing of intra-frame interpolation (k) is performed on the frame P1. In the example illustrated in FIG. 4, intra-frame interpolation processing is performed to generate interpolation frames during the exposure time corresponding to time T1 to time T2.

In step S53, the processing of intra-frame interpolation (k+1) is performed on the frame P2. In the example illustrated in FIG. 4, intra-frame interpolation processing is performed to generate interpolation frames during the exposure time corresponding to time T3 to time T4.

By performing the processing of step S52, the last interpolation frame Pa5 in a period of time T1 to time T2 is acquired. Next, by performing the processing of step S53, the top interpolation frame Pa6 in a period of time T3 to time T4 is acquired.

In step S54, the inter-frame interpolation (k) is performed on the frame P1. The inter-frame interpolation (k) for the frame P1 is the inter-frame interpolation processing performed during the non-exposure time of time T2 to time T3 corresponding to a read period for the frame P1 in FIG. 4. Since the interpolation frame Pa5 and the interpolation frame Pa6 have been acquired when the processing of step S54 is performed, these interpolation frames Pa are used to generate the interpolation frames Pb1 to Pb4.

In step S55, the number k is changed to 2 and then the processing returns to step S53. In step S53, the intra-frame interpolation (k+1) is performed on the frame P3, and in step S54, the inter-frame interpolation (k) is performed on the frame P2.

In the processing of step S54 for the second and subsequent times, the processing of step S52 is not performed because the last interpolation frame Pa and the top interpolation frame Pa necessary for performing the inter-frame interpolation (k) have already been acquired. Specifically when the frame interpolation processing is started (when k=1 is set), the intra-frame interpolation processing is performed twice in succession. After that, the processing continues in which the intra-frame interpolation processing and the inter-frame interpolation processing are alternately repeated.

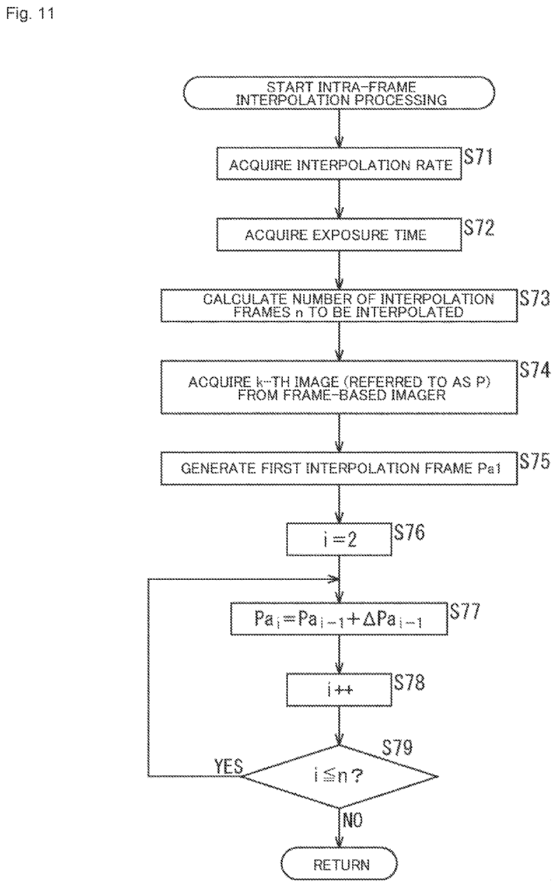

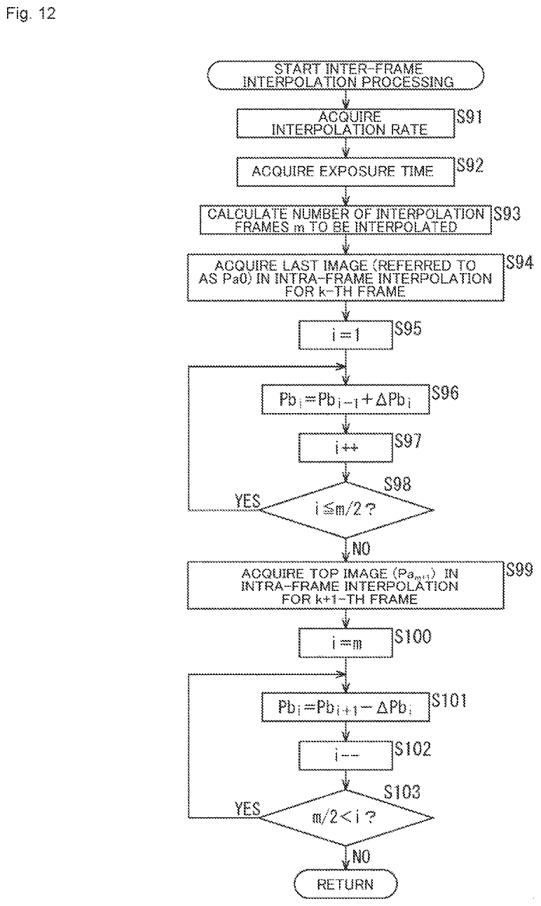

Returning to the processing of the flow chart illustrated in FIG. 10, the processing related to the intra-frame interpolation performed in steps S52 and S53 will be described later with reference to a flowchart of FIG. 11. The processing related to the inter-frame interpolation performed in step S54 will be described later with reference to a flowchart of FIG. 12.

In step 555, the value of number k is incremented by 1 and the next frame is to be processed. In step S56, it is determined whether or not to end the processing. For example, when all the frames stored in the data storage unit 42 have been processed, or when the capturing by the camera unit 22 has ended, it is determined in step S56 to end the processing.

On the other hand, if it is determined in step S56 not to end the processing, the processing is returned to step S53 to repeat the subsequent steps of processing.

### <Processing Related to Intra-Frame Interpolation>

The intra-frame interpolation processing performed in steps S52 and S53 will be described with reference to the flowchart of FIG. 11. Since the intra-frame interpolation has been described with reference to FIGS. 4 and 5, redundant description will be omitted as appropriate.

In step S71, the interpolation rate is acquired. In step S72, the exposure time is acquired. In step S73, the number of frames n to be interpolated is calculated.

The number of frames n to be interpolated in the intra-frame interpolation is calculated based on the above Equation (6), and is calculated using the interpolation rate, the exposure time, and the non-exposure time. In Equation (6), (exposure time+non-exposure time) can be calculated from the frame rate. In step S73, the interpolation rate acquired in step S71, the exposure time acquired in step S72, and the (exposure time+non-exposure time) calculated from the frame rate are used to calculate the interpolation frame number n to be interpolated.

In step S74, the k-th image (frame) from the frame-based imager 32 is acquired. The frame to be acquired may be a frame directly supplied from the frame-based imager 32 to the interpolation image generation unit 43 or may be a frame stored in the data storage unit 42. The k-th frame acquired in step S74 is here referred to as a frame P.

At step 575, the first interpolation frame Pa1 is generated. As described with reference to FIG. 5, the first interpolation frame Pa1 is generated based on Equation (5) using the frame P and the integrated event data ΔPa acquired during the exposure time.

In step S76, i is set to 2. At step S77, the i-th interpolation frame Pa₁ is generated. The interpolation frame Pa₁ is generated by adding the integrated event data ΔPai−1 to the previous interpolation frame Pai−1. For example, in the example illustrated in FIG. 5, the interpolation frame Pa2 is generated by adding the integrated event data ΔPa1 to the interpolation frame Pa1.

In step S78, i is incremented by 1. In step S79, it is determined whether or not i is equal to or less than n (i≤n). If it is determined in step S79 that i is equal to or less than n, the processing returns to step S77 to repeat the subsequent steps of processing. In other words, the generation of interpolation frames Pa is repeated until the number of frames reaches the set number of interpolation frames n to be interpolated.

On the other hand, if it is determined in step S79 that i is not equal to or less than n, in other words, if it is determined that i is greater than n, the processing related to the generation of interpolation frames Pa to be processed for the exposure time is generated ends.

### <Processing Related to Inter-Frame Interpolation>

The inter-frame interpolation processing performed in step S54 (FIG. 10) will be described with reference to the flowchart of FIG. 12. Since the inter-frame interpolation has been described with reference to FIGS. 4 and 7, redundant description will be omitted as appropriate.

In step S91, the interpolation rate is acquired. In step S92, the exposure time (or non-exposure time) is acquired. In step S93, the number of frames m to be interpolated is calculated.

When the processing is performed in accordance with the flowchart illustrated in FIG. 10, for example, since the intra-frame interpolation (k) is performed at a time before the inter-frame interpolation (k) is performed in step S54 and the interpolation rate and the exposure time have been acquired, the processing of steps S91 and S92 may be omitted, and the already acquired interpolation rate and exposure time may be used.

The number of interpolation frames m to be interpolated in step S93 is calculated based on the above Equation (15). In step S93, the interpolation rate acquired in step S91, the exposure time (or the non-exposure time) acquired in step S92, and the (exposure time+non-exposure time) calculated from the frame rate are used to calculate the interpolation frame number n to be interpolated.

As described with reference to FIG. 7, in the inter-frame interpolation, the non-exposure time is divided into the first half and the second half, and an interpolation frame Pb is generated by adding an integrated event data ΔPb in the first half, and an interpolation frame Pb is generated by subtracting an integrated event data ΔPb in the second half. The processing of steps S94 to S98 is processing related to generation of interpolation frames Pb in the first half of the non-exposure time, and the processing of steps S99 to S103 is processing related to generation of interpolation frames Pb in the second half of the non-exposure time.

In step S94, the last interpolation frame Pa in the intra-frame interpolation for the k-th frame is acquired. The last interpolation frame Pa stored in the data storage unit 42 is acquired. The interpolation frame Pa for the k-th frame P acquired in step S94 is here referred to as an interpolation frame Pa0.

In step S95, i is set to 1. In step S96, the i-th interpolation frame Pbi is generated. The interpolation frame Pbi is generated by adding the integrated event data ΔPbi to the previous interpolation frame Pbi−1. The first interpolation frame Pb1 is generated using the last interpolation frame Pa. This last interpolation frame Pa is also an interpolation frame and can be treated as an interpolation frame Pb0 (i=1).

For example, when i=1 in the example illustrated in FIG. 7, the interpolation frame Pb1 is generated by adding the integrated event data ΔPb1 to the interpolation frame Pa1 (corresponding to the interpolation frame Pb0). When i=2 in the example illustrated in FIG. 7, the interpolation frame Pb2 is generated by adding the integrated event data ΔPb2 to the interpolation frame Pb1.

In step S97, i is incremented by 1. In step S98, it is determined whether or not i is equal to or less than (m/2) (i≤m/2). If it is determined in step S98 that i is equal to or less than (m/2), the processing returns to step S96 to repeat the subsequent steps of processing. In other words, the generation of interpolation frames Pb is repeated until the number of interpolation frames Pb reaches half the set number of interpolation frames m to be interpolated.

On the other hand, if it is determined in step S98 that i is not equal to or less than (m/2), the processing proceeds to step S99.

In step S99, the top interpolation frame Pa in the intra-frame interpolation for the k+1-th frame is acquired. The top interpolation frame Pa stored in the data storage unit 42 is acquired. The interpolation frame Pa for the k+1-th frame P acquired in step S99 is here referred to as an interpolation frame Pam+1.

In step S100, i is set to m. In step S101, the i-th interpolation frame Pbi is generated. The interpolation frame Pbi is generated by subtracting the integrated event data ΔPbi from the next interpolation frame Pbi+1. The i-th interpolation frame Pb1 is generated using the top interpolation frame Pam+1. This top interpolation frame Pam+1 is also an interpolation frame and can be treated as an interpolation frame Pbm+1 (i=m).

For example, in the example illustrated in FIG. 7, when i=m and m is 4, the interpolation frame Pb4 is generated by subtracting the integrated event data ΔPb4 from the interpolation frame Pa6 (corresponding to the interpolation frame Pbm+1). In the example illustrated in FIG. 7, when i=m−1=3, the interpolation frame Pb3 is generated by subtracting the integrated event data ΔPb3 from the interpolation frame Pb4.

In step S102, i is decremented by 1. In step S103, it is determined whether or not i is greater than (m/2) (m/2<i). If it is determined in step S103 that i is greater than (m/2), the processing returns to step S101 to repeat the subsequent steps of processing. In other words, the generation of interpolation frames Pb is repeated until the number of interpolation frames Pb reaches the number of frames obtained by subtracting the number of interpolation frames Pb already generated in the processing of steps S94 to S98 from the set number of interpolation frames m to be interpolated.

In this way the event data from the event-based imager 33 is used for the moving image acquired from the frame-based imager 32 to generate interpolation frames, thereby generating a moving image with a high frame rate.

<Dealing with Sudden Change in Luminance>

The above-described embodiment can be applied to both the case where the output from the event-based imager 33 includes gradation output and the output from the event-based imager 33 does not include gradation output (the case of code output).

Even in the case where the output from the event-based imager 33 does not include gradation output, it can be regarded to be handled without being inferior to the case of including gradation output because the output from the event-based imager 33 is generally larger than the output from the frame-based imager 32.

For example, if the frame-based imager 32 is compatible with high dynamic range (HDR), it can follow the international standard ITU-R BT.2100 that specifies a gradation of 10 or 12 bits, which corresponds to 72 db and approximately 4000 gradations. Assuming that the moving image frame rate of the frame-based imager 32 is 120 FPS, it is approximately 8.3 msec/frame.

The event-based imager 33 provided as a product by the present applicant has HDR characteristics of 124 db or more, is capable of detecting an event even at low illumination, for example, 40 mlx, and has high time resolution (accuracy in microseconds).

From these facts, it can be said that the event-based imager 33 has sufficient accuracy in both luminance resolution and time resolution as compared with the frame-based imager 32. Even if the output from the event-based imager 33 does not include gradation output and instead outputs a sign (+1 or −1) representing a change in luminance, the above-described performance allows gradation conversion from event-based luminance to frame-based luminance to be calculated by a simple proportional calculation such as how many event-based events correspond to one frame-based gradation.

Thus, as described above, the output from the event-based imager 33 can be applied to the present technology both in the case of including gradation output and in the case of not including gradation output (the case of code output).

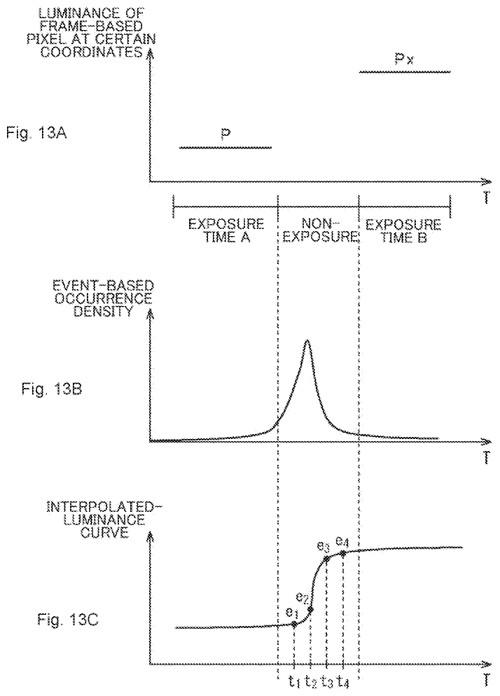

Note that for a sudden change in luminance, it may be impossible to use the proportional conversion. Such a case can be dealt with by a method described with reference to FIG. 13.

As illustrated in A of FIG. 13, when there is a large difference between the luminance of (a pixel at certain coordinates of) a frame P acquired in an exposure time A and the luminance of (a pixel at certain coordinates of) a frame Px acquired in the next exposure time B, occurrence densities of events that occurred between the times are obtained. In the situation as illustrated in A of FIG. 13, the occurrence densities of events are graphed such that it has a peak in the non-exposure time, as illustrated in B of FIG. 13.

By time-integrating the occurrence densities and adding the resulting value to the luminance of the corresponding pixel, an interpolated-luminance curve in FIG. 13 is obtained. A luminance gradation obtained from this interpolated-luminance curve is treated as event data from the event-based imager 33. For example, in the non-exposure time, when an interpolation frame Pb is generated at each of times t1 to t4, and when the vertical axis of the graph in C of FIG. 13 represents an amount of conversion of luminance, event data e1 at time t1 is a value that intersects the interpolated-luminance curve at time t1.

Similarly, event data e2 at time t2 is a value that intersects the interpolated-luminance curve at time t2, event data e3 at time t3 is a value that intersects the interpolated-luminance curve at time t3, and event data e4 at time t4 is a value that intersects the interpolated-luminance curve at time t4.

In this way, when the luminance changes suddenly the amount of change in luminance included in the event data may be set using an interpolated-luminance curve generated from the event-based occurrence densities. For a sudden change in luminance, a flow may be provided in which when a graph of event-based occurrence densities is created as illustrated in B of FIG. 13, if the graph has a peak exceeding a threshold, it is determined that a sudden change in luminance occurs.

### <Application to Still Image>

In the above-described embodiment, the case of generating a moving image has been described by way of example. However, the present technology can also be applied to the case of generating a still image.

The intra-frame interpolation processing for a moving image described above can be applied to the generation of a still image from which motion blur has been removed. The still image can be regarded as one image when the number of frames to be interpolated is approached to infinity in the intra-frame interpolation processing described with reference to FIG. 5, and can be obtained by the following Equation (16).

$$\begin{matrix}[ Math . 7 ] & \\ {P}_{T} = P + \frac{1}{{T}_{E}} {\sum }_{{t}_{e} = 0}^{T} {t}_{e} Δ {P}_{{t}_{e}} - \frac{1}{{T}_{E}} {\sum }_{{t}_{e} = T}^{{T}_{E}} ( {T}_{E} - {t}_{e} ) Δ {P}_{{t}_{e}} & ( 16 )\end{matrix}$$

In Equation (16), T_{E} represents the exposure time of the frame-based imager 32. T represents the time of the still image to be obtained. The time represented by T is the time when the exposure start time is set to 0. te represents the time when an event occurred. ΔPte represents event data (luminance difference image) of the event that occurred at te.

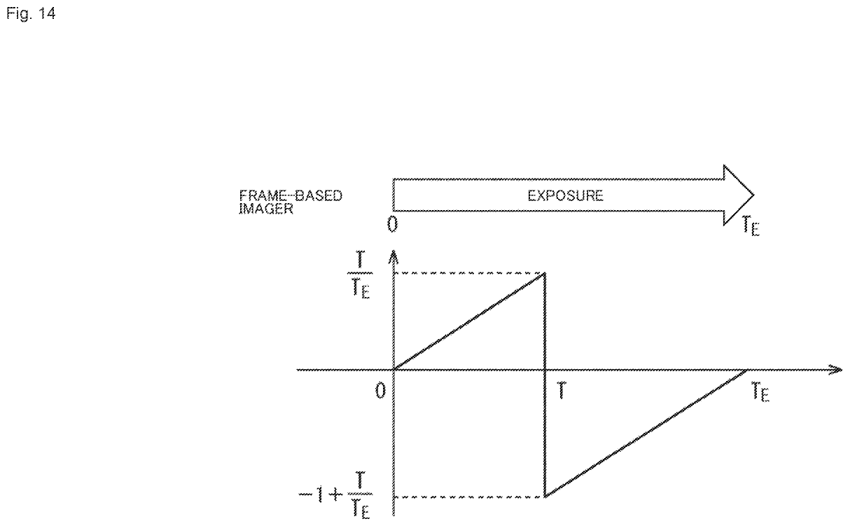

Equation (16) means multiplication using the coefficient represented by the graph illustrated in FIG. 14 and addition of the resulting values. Referring to FIG. 14, there is time T between time 0 and time TE in the exposure time. The coefficient between time 0 and time T increases linearly from 0 to (T/T_{E}). This part relates to the operation of the second term on the right side of Equation (16).

The coefficient from time T to time T_{E} increases linearly from (−1+T/T_{E}) to 0. This part relates to the operation of the third term on the right side of Equation (16).

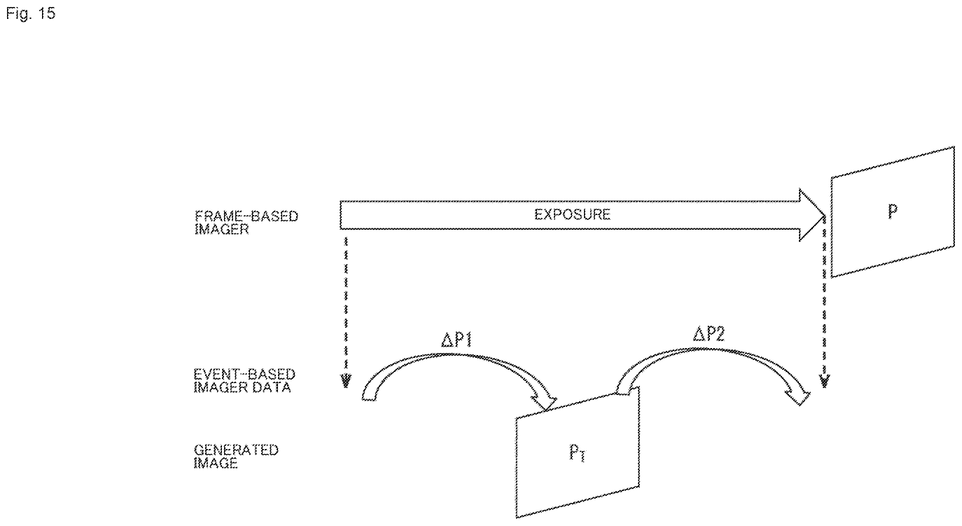

Obtaining a still image P_{T} at time T based on Equation (16) provides highly accurate processing. On the other hand, in order to obtain a still image P_{T} with time T set in the middle of the exposure time as illustrated in FIG. 15, in other words, in order to obtain a still image P_{T} simply the still image P_{T} can be obtained by Equation (17).

$$\begin{matrix}[ Math . 8 ] & \\ {P}_{T} = P + \frac{1}{4} Δ {P}_{1} - \frac{1}{4} Δ {P}_{2} & ( 17 )\end{matrix}$$

When a frame P is obtained as a result of the frame-based imager 32 exposing from time 0 to time T_{E}, in order to obtain a still image at the middle point (time T) of the exposure time, the still image can be calculated using the frame P, integrated event data ΔP1 from time 0 to time T, and integrated event data ΔP2 from time T to time T_{E}, as represented in Equation (17).

In the above example, time T is the middle point of the exposure time. However, a time other than the middle point may be set so that it can be simply obtained.

Time T may be changed so that a plurality of still images can be generated. For example, the exposure time may be equally divided into five so that a still image P_{T} may be generated at each of time T1, time T2, time T3, time T4, and time T5 (=time T_{E}). When a plurality of still images P_{T} are generated in this way, in this case, five still images P_{T}, all the five generated still images P_{T} may be stored. The five still images P_{T} may be presented to the user, and one or more still images P_{T} selected by the user may be stored.

In this way, the frame P obtained by the frame-based imager 32 and the event data (integrated event data ΔP) obtained by the event-based imager 33 can be used to generate a still image from which motion blur has been removed.

According to the present technology it is possible to provide an imaging device with a high frame rate. Since the event data from the event-based imager 33 is used, even an image of a subject with low illumination can be captured at a high frame rate. It is possible to eliminate or reduce the limit on the continuous capturing time. According to the present technology, it is also possible to add a deblur (motion blur removal) function for still images.

### <Recording Medium>

The above-described series of steps of processing may be performed by hardware or software. When the series of steps of processing is performed by software, a program of the software is installed in a computer. Here, the computer includes a computer built into dedicated hardware or, for example, a general-purpose personal computer capable of executing various functions by various programs being installed.

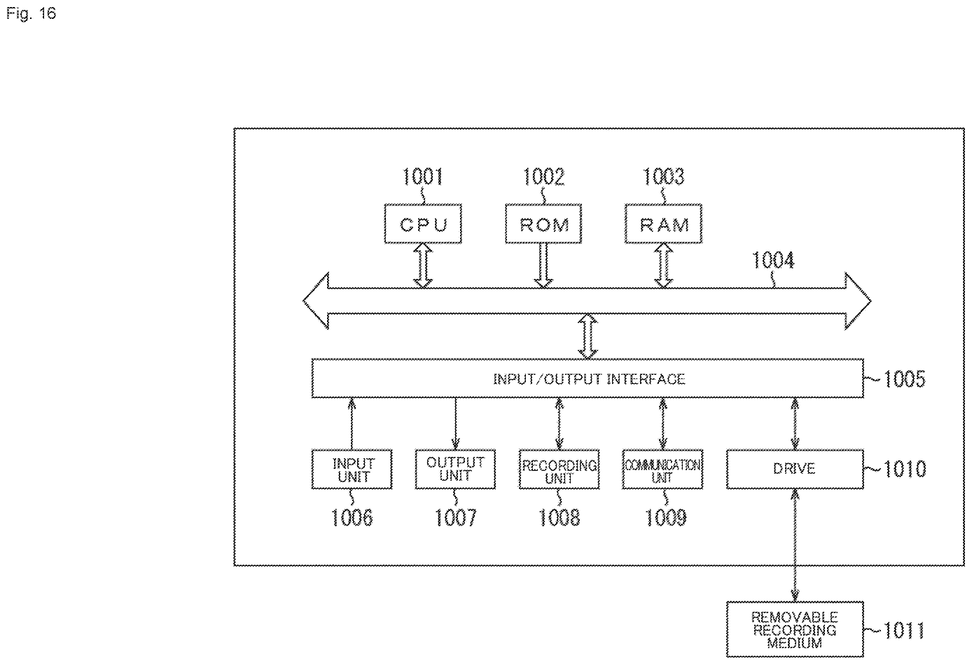

FIG. 16 is a block diagram illustrating an example of a hardware configuration of a computer that executes the above-described steps of processing by a program. In the computer, a central processing unit (CPU) 1001, a read only memory (ROM) 1002, and a random access memory (RAM) 1003 are connected to each other by a bus 1004. An input/output interface 1005 is further connected to the bus 1004. An input unit 1006, an output unit 1007, a storage unit 1008, a communication unit 1009, and a drive 1010 are connected to the input/output interface 1005.

The input unit 1006 includes a keyboard, a mouse, a microphone, and the like. The output unit 1007 includes a display, a speaker, and the like. The storage unit 1008 includes a hard disk, a non-volatile memory and the like. The communication unit 1009 includes a network interface and the like. The drive 1010 drives a removable recording medium 1011 such as a magnetic disk, an optical disc, a magneto-optical disk, or a semiconductor memory.

In the computer configured as described above, the CPU 1001 loads, for example, a program stored in the storage unit 1008 into the RAM 1003 via the input/output interface 1005 and the bus 1004, and executes the program so that the above-described series of steps of processing are performed.

The program to be executed by the computer (the CPU 1001) can be provided in such a manner as to be recorded on, for example, the removable recording medium 1011 serving as a packaged medium. The program can also be provided via a wired or wireless transmission medium such as a local area network, the Internet, or digital satellite broadcasting.

In the computer, by mounting the removable recording medium 1011 on the drive 1010, it is possible to install the program in the storage unit 1008 via the input/output interface 1005. Further, the program can be received by the communication unit 1009 via the wired or wireless transmission medium and installed in the storage unit 1008. Further, the program can be installed in the ROM 1002 or the storage unit 1008 in advance.

The program to be executed by a computer may be a program that performs processing chronologically in the order described herein or may be a program that performs processing in parallel or at a necessary timing such as a called time.

The system as used herein refers to an entire device configured of a plurality of devices.

The effects described herein are merely examples and are not limited, and other effects may be obtained.

Embodiments of the present technology are not limited to the above-described embodiment and various modifications can be made during the scope of the present technology without departing from the spirit and scope of the present technology.

The present technology can also be configured as follows.

(1)

An image processing device including:
a frame-based first imaging element;
an event-based second imaging element; and
a generation unit that generates an interpolation frame by using frame data from the first imaging element and event data from the second imaging element.
   (2)

The image processing device according to (1), wherein the generation unit generates the interpolation frame by adding, to the interpolation frame, integrated event data obtained by integrating the event data generated within a predetermined period of time.

(3)

The image processing device according to (2), wherein the generation unit generates, by using first frame data obtained in a first exposure time of the first imaging element and a plurality of pieces of integrated event data obtained in the first exposure time, a top interpolation frame in the first exposure time.

(4)

The image processing device according to any one of (1) to (3), wherein the generation unit generates the interpolation frame by adding or subtracting, to or from the interpolation frame, integrated event data obtained by integrating the event data generated within a predetermined period of time.

(5)

The image processing device according to (4), wherein the generation unit generates, by using
a last interpolation frame among a plurality of interpolation frames generated as interpolation frames during the first exposure time,
a top interpolation frame among a plurality of interpolation frames generated by adding second frame data obtained by the first imaging element during a second exposure time after the first exposure time and the integrated event data obtained in the second exposure time, and
the integrated event data obtained in a non-exposure time between the first exposure time and the second exposure time,
an interpolation frame for the non-exposure time.
   (6)

The image processing device according to (5), wherein
when generating the interpolation frame located in the first half of the non-exposure time, the generation unit generates the interpolation frame by using the last interpolation frame and the integrated event data obtained in the first half of the non-exposure time, and
when generating the interpolation frame located in the second half of the non-exposure time, the generation unit generates the interpolation frame by using the top interpolation frame and the integrated event data obtained in the second half of the non-exposure time.
   (7)

The image processing device according to (1), wherein a still image at a predetermined time in an exposure time is generated by adding and subtracting the event data acquired in the exposure time to and from the frame data.

(8)

An image processing method including: by an image processing device including a frame-based first imaging element and
an event-based second imaging element,
generating an interpolation frame by using frame data from the first imaging element and event data from the second imaging element.
   (9)

A program causing a computer for controlling an image processing device including a frame-based first imaging element and
an event-based second imaging element
to execute processing including
a step of generating an interpolation frame by using frame data from the first imaging element and event data from the second imaging element.
   (10)

An image processing device including: a generation unit that generates an interpolation frame that interpolates between a first frame and a second frame by using event data obtained from an event-based imaging element and frame data.

(11)

The image processing device according to (10), wherein the first frame and the second frame are frames captured by a frame-based imaging element.

(12)

The image processing device according to (10) or (11), wherein the first frame and the second frame are interpolation frames generated by the generation unit.

(13)

An image processing method including: by an image processing device, generating an interpolation frame that interpolates between a first frame and a second frame by using event data obtained from an event-based imaging element and frame data.

(14)

A program causing a computer to execute processing including a step of generating an interpolation frame that interpolates between a first frame and a second frame by using event data obtained from an event-based imaging element and frame data.

### REFERENCE SIGNS LIST

11 Image processing device
21 Lens
22 Camera unit
23 Image generation unit
31 Half mirror
32 Frame-based imager
33 Event-based imager
34 Inter-imager correction calculation unit
35 Calibration unit
41 Event integration unit
42 Data storage unit
43 Interpolation image generation unit
51 Hybrid imager

1. An image processing device comprising:
a frame-based first imaging element;
an event-based second imaging element; and
a generation unit that generates an interpolation frame by using frame data from the first imaging element and event data from the second imaging element.

2. The image processing device according to claim 1, wherein the generation unit generates the interpolation frame by adding, to the interpolation frame, integrated event data obtained by integrating the event data generated within a predetermined period of time.

3. The image processing device according to claim 2, wherein the generation unit generates, by using first frame data obtained in a first exposure time of the first imaging element and a plurality of the pieces of integrated event data obtained in the first exposure time, a top interpolation frame in the first exposure time.

4. The image processing device according to claim 1, wherein the generation unit generates the interpolation frame by adding or subtracting, to or from the interpolation frame, integrated event data obtained by integrating the event data generated within a predetermined period of time.

5. The image processing device according to claim 4, wherein the generation unit generates, by using
a last interpolation frame among a plurality of interpolation frames generated as interpolation frames during the first exposure time,
a top interpolation frame among a plurality of interpolation frames generated by adding second frame data obtained by the first imaging element during a second exposure time after the first exposure time and the integrated event data obtained in the second exposure time, and
the integrated event data obtained in a non-exposure time between the first exposure time and the second exposure time,
an interpolation frame for the non-exposure time.

6. The image processing device according to claim 5, wherein
when generating the interpolation frame located in the first half of the non-exposure time, the generation unit generates the interpolation frame by using the last interpolation frame and the integrated event data obtained in the first half of the non-exposure time, and
when generating the interpolation frame located in the second half of the non-exposure time, the generation unit generates the interpolation frame by using the top interpolation frame and the integrated event data obtained in the second half of the non-exposure time.

7. The image processing device according to claim 1, wherein a still image at a predetermined time in an exposure time is generated by adding and subtracting the event data acquired in the exposure time to and from the frame data.

8. An image processing method comprising: by an image processing device including a frame-based first imaging element and
an event-based second imaging element,
generating an interpolation frame by using frame data from the first imaging element and event data from the second imaging element.

9. A program causing a computer for controlling an image processing device including a frame-based first imaging element and
an event-based second imaging element
to execute processing comprising
a step of generating an interpolation frame by using frame data from the first imaging element and event data from the second imaging element.

10. An image processing device comprising: a generation unit that generates an interpolation frame that interpolates between a first frame and a second frame by using event data obtained from an event-based imaging element and frame data.

11. The image processing device according to claim 10, wherein the first frame and the second frame are frames captured by a frame-based imaging element.

12. The image processing device according to claim 10, wherein the first frame and the second frame are interpolation frames generated by the generation unit.

13. An image processing method comprising: by an image processing device, generating an interpolation frame that interpolates between a first frame and a second frame by using event data obtained from an event-based imaging element and frame data.

14. A program causing a computer to execute processing comprising
a step of generating an interpolation frame that interpolates between a first frame and a second frame by using event data obtained from an event-based imaging element and frame data.
